(19) United States
(12) Patent Application Publication
(10) Pub. No.: US 2019/0266812 A1
(43) Pub. Date: Aug. 29, 2019

(54) VEHICULAR ENGINE ACOUSTIC IDENTIFICATION

(71) Applicant: VORBECK MATERIALS CORP., JESSUP, MD (US)

(72) Inventor: JOHN S LETTOW, WASHINGTON, DC (US)

(73) Assignee: VORBECK MATERIALS CORP., JESSUP, MD (US)

(21) Appl. No.: 15/061,814

(22) Filed: Mar. 4, 2016

(51) Int. Cl. G07C 5/08; G01M 15/12; G01M 15/02; G01M 13/028

(52) U.S. Cl. CPC G07C 5/0808; G01M 15/12; G07C 5/085; G01M 13/028; G07C 5/0825; G01M 15/02

(57) ABSTRACT

Embodiments of the present invention relate to ascertaining the operational fitness of mechanical systems. In an embodiment, a MS facing (“MSF”) detector is positioned proximate to the MS in a manner to detect acoustic pressure (“AP”) emanating from the MS. A computing device is in electrical communication with the MSF detector that correlates detected AP with the MS's operational profile and generates a notification when the correlated data exceeds a predetermined threshold by a predetermined percentage. The computing device transmits the generated notification to a user-facing display.

### CROSS-REFERENCE TO RELATED APPLICATIONS

This application claims priority to U.S. Provisional Application No. 62/099,505 filed Jan. 4, 2015, and is hereby incorporated herein by reference

### BACKGROUND

### Technical Field

The present invention relates generally to predictive maintenance tools and specifically to mechanical system acoustic pressure identification. Mechanical systems typically emit sound (“acoustic pressure”) during the course of their operation. However, the appearance of abnormal acoustic pressure typically reflects that the MS is operating in a non-ideal manner. When abnormal acoustic pressure is detected by interested persons, the MS is typically sent for inspection and/or servicing.

### BRIEF DESCRIPTION OF THE DRAWINGS

FIG. 1 depicts a block diagram of an environment, generally 100, in accordance with an embodiment of the present invention.

FIG. 2 depicts a vehicular platform, generally 210, in accordance with an embodiment of the present invention.

FIG. 3 illustrates the underside of a vehicle engine compartment hood, generally 300, in accordance with an embodiment of the present invention.

FIG. 4 illustrates the underside of a VECH, generally 400, in accordance with an embodiment of the present invention.

FIG. 5 depicts the operational steps of a program function, generally 112, in accordance with an embodiment of the present invention.

FIG. 6 depicts a block diagram of components of a computing device, in accordance with an embodiment of the present invention.

### DETAILED DESCRIPTION

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (“RAM”), a read-only memory (“ROM”), an erasable programmable read-only memory (EPROM or Flash memory), an optical fiber, a portable compact disc read-only memory (“CD-ROM”), an optical storage device, a transmission media such as those supporting the Internet or an intranet, or a magnetic storage device.

Note that the computer-usable or computer-readable medium could even be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

The present invention is described below with reference to flow chart illustrations and/or block diagrams of methods, apparatus (systems) and computer program products according to embodiments of the present invention. It will be understood that each block of the flow chart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the FIGS. illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The nature of acoustic pressure (“AP”) can be utilized to determine the operational fitness of mechanical components and/or mechanical systems (“MS”). AP are sound waves, which can be defined by their amplitude, wavelength, period, frequency, and speed. Amplitude refers to the height of the wave. Wavelength refers to the distance between adjacent crests. Period refers to the time it take for one complete wave to pass a given point. Frequency refers to the number of complete waves that pass a point in one second, measured in inverse second, or Hertz. Speed refers to the horizontal speed of a point on a wave as it propagates, typically the quotient of wavelength and period or the product of wavelength and frequency.

APs have frequencies, amplitudes, tones, and harmonics. MSs typically emit acoustic pressure during the course of their normal operation, but the appearance of abnormal acoustic pressure (“AAP”). As used herein, AAP is defined as AP that is above a predetermined threshold as defined by historic AP measurements (“APM”) and/or percent changes above predetermined APMs under similar operating conditions. Operating conditions can comprise RPM, altimetry, velocity, geospatial, operating temperature under which the mechanical system operates under. Geospatial data comprises GPS location-based information. AAP emanating from a MS typically reflects a need to have the AP source identified and/or the MS inspected, for example, by the user, a repair specialist, and/or persons associated therewith.

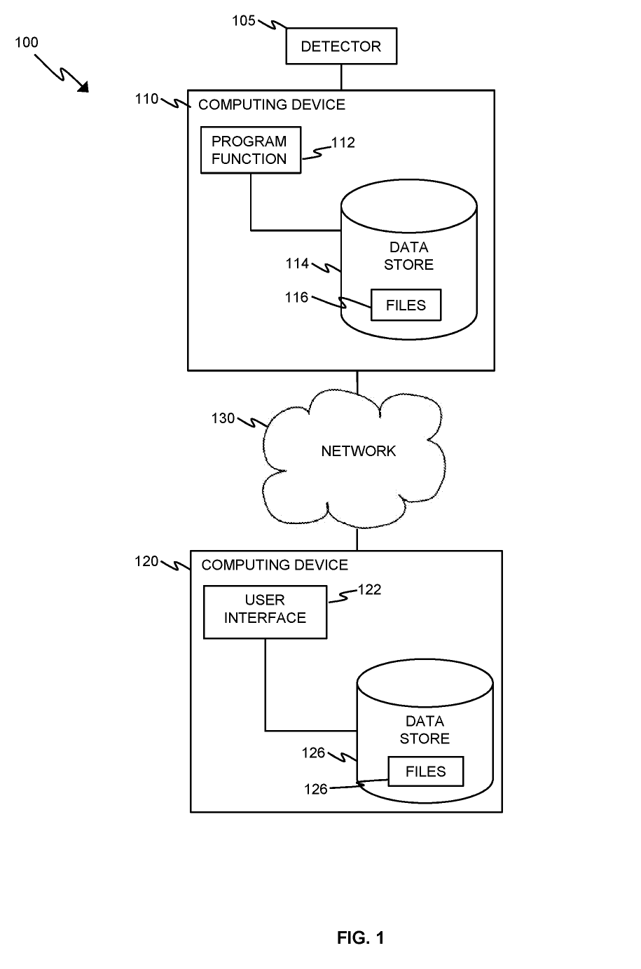

Embodiments of the present invention seek to provide detectors for measuring acoustic pressure. Other aspects of the present invention seek to provide detectors capable of receiving AP associated with a MS. Additional aspects of the present invention seek to provide systems for monitoring the operational fitness of an MS. For example, MSs can include, but are not limited to, IC engines, electrical motors, drivelines, transmissions, brake systems, HVAC systems, alternators, and engine accessories. In general, a MS can be any system of elements that interact on mechanical principals, in accordance with an embodiment of the present invention. Other aspects of the present invention seek to provide real-time MS diagnostics. FIG. 1 depicts a block diagram of an environment, generally 100, in accordance with an embodiment of the present invention. Environment 100 includes computing devices 120 and 110, in communication via network 130, and detector 105, which is in communication with computing device 110, in accordance with an embodiment of the present invention.

Network 130 may be a local area network (LAN), a wide area network (WAN) such as the Internet, a cellular data network, any combination thereof, or any combination of connections and protocols that will support communications between user computing devices 110 and 120, in accordance with embodiments of the invention. Network 130 may comprise wired, wireless, or fiber optic connections.

Computing device 110 and/or 120 may be a desktop computer, a laptop computer tablet computer, a personal digital assistant (PDA), a wearable computer, or a smart phone. In general, computing devices 110 and/or 120 may be any electronic device or computing system capable of sending data, receiving data, and/or communicating with additional computing devices over network 130. Computing device 120 is a user-facing device that monitors and/or displays operational fitness data received from program function 112, in accordance with an embodiment of the present invention. Computing device 120 can include user interface 122 and data store 126. Data store 126 is an information store that includes files 126. Files 126 can comprise real time APM, correlated APM, historic APM, and/or threshold information. Files 126 can include notifications generated by program function 112. Applicable notifications can include information reflecting the operational fitness.

User interface 122 is user-facing hardware that interface with computing device 120, in accordance with an embodiment of the present invention. User interface 122 can be graphics-based, gesture-based, and/or text-based. User interface 122 can be a touchscreen and/or computer monitor. User interface 122 can be a motion tracking interface. User interface 122 can display notifications, APM, and correlated APM generated by program function 112. Computing device 120 can be an user facing diagnostic tool utilized by one interested in the operational fitness of MSs, such as owners, users, repair technicians, and/or diagnostic experts.

Detector 105 is MS facing device that measures AP, in accordance with an embodiment of the present invention. Detector 105 can measure the intensity and/or frequency of AP measurements (APMs). Detector 105 comprises one or more emitter optical fibers that emit light towards the optical fiber facing side of a diaphragm comprising, for example, graphene. Graphene-based compositions allow for the formation of thinner, and thereby more sensitive, diaphragms without sacrificing structural integrity. Detector 105 includes an interstice between the one or more optical fibers and the diaphragm. The optical fiber facing side of the diaphragm may comprise reflective material to achieve desired reflectivity characteristics. The reflective material may comprise a coating applied to the surface of the diaphragm. Applicable reflective material can comprise metals and/or reflective polymers. The diaphragm may comprise a printed graphene-based composition. Applicable graphene material and/or compositions utilized in the present invention may be derived and/or formed utilizing a plurality of methods, including, but not limited to, those disclosed by, U.S. Pat. No. 7,658,901 B2 by Prud′Homme et al, United States patent application 2011/0189452 A1 by Lettow et al., United States patent application 2014/0050903 A1 by Lettow et al. and/or U.S. Pat. No. 8,278,757 B2 by Crain et al, which are hereby incorporated by reference in their entirety.

Detector 105 can have one or more receiving optical fibers arranged laterally to the emitting fiber to receive at least a portion of transmitted light reflected by the optical fiber facing side of the diaphragm and comprises a light sensing means coupled to the distal end of the one or more receiving fibers. For example, the light sensing means is a light sensor. In the operation of certain embodiments, light is transmitted by the one or more emitting optical fibers, reflected by the optical fiber facing side of the diaphragm into the receiving optical fiber(s), wherein it is detected by the light sensing means. In response to a change in atmospheric pressure, pressure waves impact the MS facing side of the diaphragm which results in a distortion thereof, which results in a change in the width of the interstice as well as a modulation of the amount of light reflected by the diaphragm. In this manner, the amount of light received by the receiving optical fiber(s) is thereby proportional to the intensity of the AP.

A theoretical basis for intensity modulated fiber optic pressure sensors and multiple embodiments of such sensors with pressure-deflected diaphragms that may constitute detector 105 is disclosed in U.S. Pat. No. 7,020,354, the disclosure of which is incorporated herein in its entirety. Detector 105 may be fabricated in a manner to operate in MS operating conditions (“operational profile”), as defined by the temperature, moisture/humidity, and/or vibrational conditions thereof. Detector 105 can measure and/or detect AP having a frequency of about 1 Hz to about 40,000 Hz, as well as any sub-range and/or value therein.

One or more copies of detector 105 can be positioned proximate to and facing the MS. One or more copies of detector 105 can be positioned proximate to the underside of MS covers, enclosures, and/or hoods. One or more copies of detector 105 can be utilized to measure a plurality of frequency ranges. One more copies of detector 105 may be deployed in a plurality of different locations to differentiate between AP sources. The one or more copies of detector 105 may be multiplexed in a manner such that the several detectors may share common components. Multiplexing of multiple optical pressure sensors, such as those described above, is disclosed in U.S. Pat. No. 7,379,630, the disclosure of which is incorporated herein in its entirety.

Computing device 110 is hardware that analyzes APMs, in accordance with an embodiment of the present invention. Computing device 110 can include data store 114 and program function 112. Data store 114 can be in communication with program function 112. Data stores of the present invention can be external to the computing devices thereof and in direct communication with network 130. Data store 114 is an information store that can include files 116. Files 116 can comprise APMs generated by detector 105, historic APM associated with the MS, and/or predetermined APM. Historic APMs can be stored in data store 114 by program function 112.

Program function 112 is software that determines MS operational fitness, in accordance with an embodiment of the present invention. Program function 112 can store APMs received from detector 105 in data store 114. Program function 112 can quantify, analyze, and/or correlate APMs. For example, APMs can be correlated with various data associated with the MS, including, but not limited to, MS operating conditions, geospatial data, altimetry data, velocity data, and/or RPM. Program function 112 can determine MS operational fitness by comparing correlated APMs to historic APMs and/or predetermined AP profiles and ascertaining whether the correlated APMs are within a predetermined percentage thereof. Where correlated APMs are within the predetermined percentage, the MS can be deemed to be operating as desired. However, where APMs exceed the predetermined percentage, operational fitness is deemed questionable and an inspection of the MS may be necessary.

Program function 112 can generate repair, service, and/or operational fitness notifications. Program function 112 can track changes in APM under particular operating conditions over a predetermined time period and thereby monitor MS aging, structural health, and/or failure susceptibility. For example, tracked changes can reflect how fast correlated APMs are approaching the predetermined threshold percentage over which reflects a deterioration in operational fitness.

For example, sudden (as measured by a predetermined time frame, for example 10 seconds, t₁→t₂) and/or significant changes (as measured by a predetermined percent change) in the APMs under particular operating conditions typically indicate undesirable operational fitness. Undesirable component wear may indicate a need to service the MS. Where multiple copies of detector 105 are employed, program function 112 can determine the general and/or specific location of undesirable APMs via, for example, triangulation, time delay, or similar positioning techniques. For example, location can be determined by the detectors that receive the AP prior to other detector(s) and/or APM having the highest amplitudes. In an embodiment, operational fitness notifications reflect whether the MS requires the attention of a repair specialist. Program function 112 can transmit real-time information to computing device 120 for display by user interface 122. Transmitted data can be graphically displayed in a manner that differs from the structure the data is transmitted.

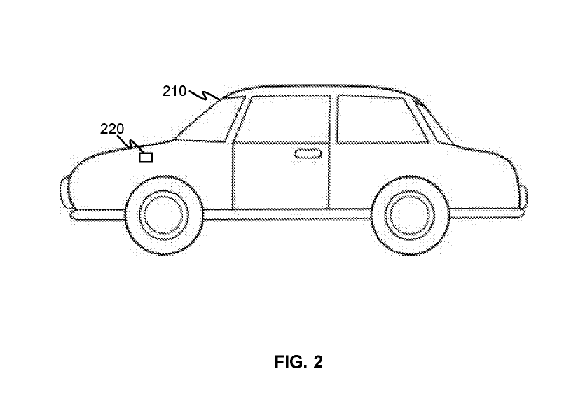

FIG. 2 depicts a vehicular platform, generally 210, in accordance with an embodiment of the present invention. Vehicular platform 210 includes system 220. System 220 includes one or more copies of computing device 110 and/or detector 105. System 220 monitors the operational fitness of the engine compartment's MS. System 220 can be positioned proximate to the engine compartment of vehicular platform 210.

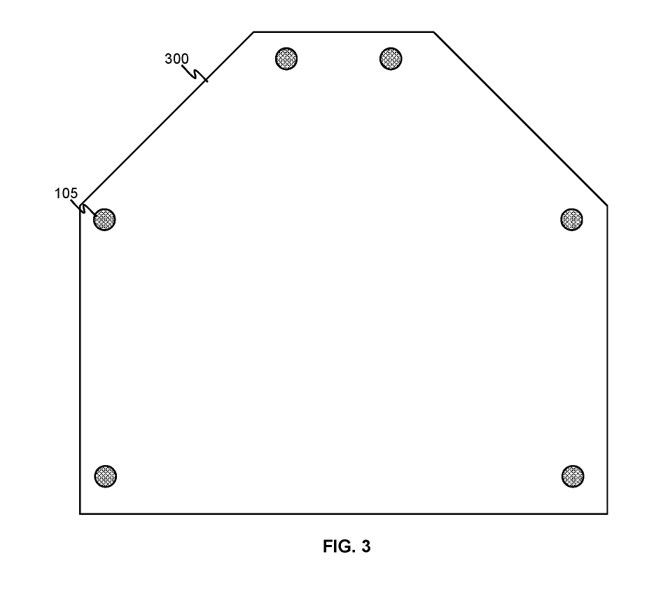

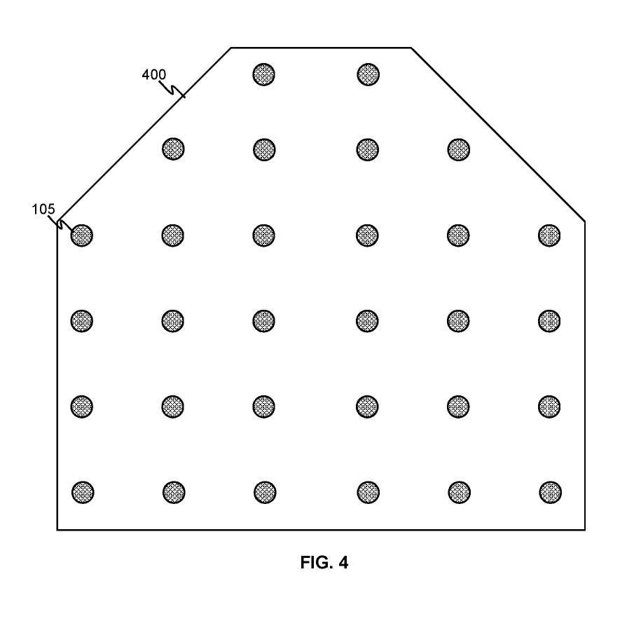

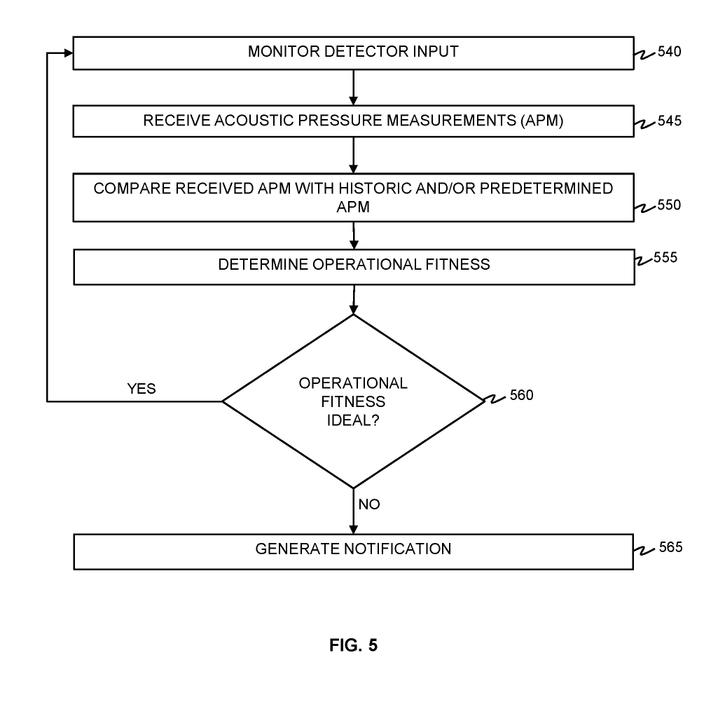

FIGS. 3 and 4 are discussed herein to facilitate the discussion of FIG. 5. FIG. 3 depicts the underside of a vehicle engine compartment hood (VECH), generally, 300, in association with an embodiment of the present invention. Specifically, FIG. 3 illustrates the engine-facing side of VECH 300, which covers at least a portion of the engine compartment of vehicle 210. VECH 300 includes multiple copies of detector 105. Although depicted as positioned proximate to the periphery of the engine-facing side of VECH 300, the multiple copies of detector 105 may be positioned in a manner that optimizes AP measurements.

The positioning of detector 105 facilitates the measurement of APs emanating from one or more MSs positioned within in the engine compartment of vehicle 210. The position of detectors 105 may be utilized to provide the particular location of APMs by, for example, triangulation, time delay technique, and/or similar locational methods.

FIG. 4 depicts the underside of a VECH, generally 400, in accordance with an embodiment of the present invention. Specifically, FIG. 4 illustrates the MS facing side of VECH 400. VECH 400 has similar functionality compared to VECH 300. VECH 400 can have positioned similarly compared to VECH 300. VECH 400 includes multiple copies of detector 105 positioned in a grid on the MS facing side of VECH 400. VECH 400 can have similar capabilities as VECH 300. Arrays of detector 105 can facilitate the identification of desirable and/or undesirable AP sources by (i) increasing the APM generating sources utilized to ascertain MS operational fitness; (ii) providing measurements of a plurality of frequency ranges; and/or (iii) providing AP source spatial location information.

FIG. 5 depicts the operational steps of program function 112, in accordance with an embodiment of the present invention. Program function 112 monitors detector input (step 540). Detector input can be received from detectors positioned on VECH 300 or VECH 400. Detectors 105 are in communication with computing device 110, which is also positioned within vehicle 210. Detectors 105 measure APs emanating from the one or more engine compartment mechanical components and/or systems. APMs are monitored by program function 112.

Program function 112 receives APMs (step 545). For example, detectors 105 measures the aforementioned APMs and transmits them to computing device 110. Program function 112 correlates the received APMs with the operational characteristics of the vehicle. In an embodiment, program function 112 transmits correlated APMs and/or associated information for display by computing device 120. Program function 112 compares the wave characteristics (i.e. frequencies, amplitudes, tone, and/or harmonics) of correlated APMs with those of historic and/or predetermined APMs (step 550). For example, program function 112 compares the correlated APMs with associated historic APMs generated by detector 105 that are included in, for example, files 116. In certain embodiments, program function 112 compares the wave characteristics of correlated APMs and with those of predetermined APM profiles included in files 116.

Program function 112 determines operational fitness (step 555). Program function 112 determines whether the operational fitness of the MS is ideal (decisional 560). For example, program function 112 ascertains whether the wave characteristics of the correlated APMs exceed those of the historic and/or predetermined APMs by a predetermined percentage. Where the predetermined percentages are exceeded the operational fitness is non-ideal. Where the predetermined percentages are not exceeded, the operational fitness is ideal. If program function 112 determines that the operational fitness of the MS is non-ideal (“no” decisional 560), program function 112 generates a notification (step 565). If program function 112 determines that the operational fitness of the MS is ideal (“yes” decisional 560), program function 112 proceeds to step 540.

In certain embodiments, program function 112 transmit the notification for display or can instruct computing device 110 to display correlated APMs and/or notifications. In other embodiments, the output of program function 112 can be controlled and/or monitored by computing device 120.

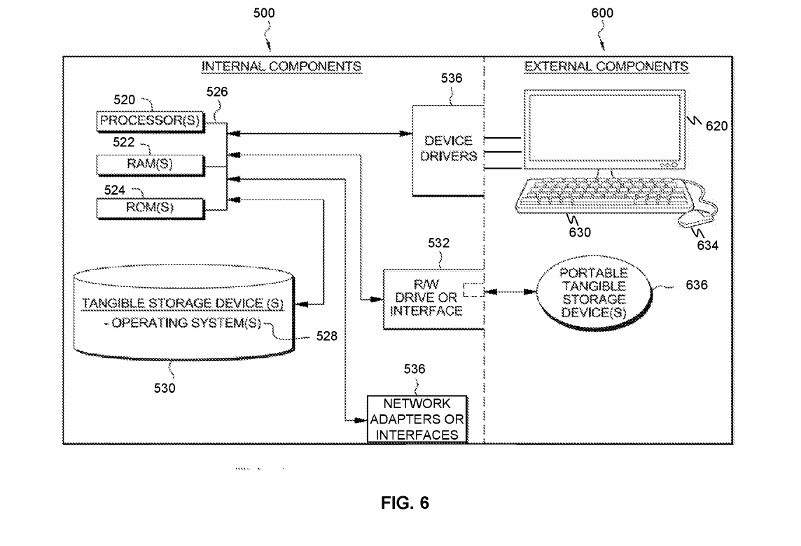

FIG. 6 depicts a block diagram of components of computing devices 110 and 120, in accordance with an embodiment of the present invention. Data processing system 500, 600 is representative of any electronic device capable of executing machine-readable program instructions. Data processing system 500, 600 may be representative of a smart phone, a computer system, PDA, or other electronic devices. Examples of computing systems, environments, and/or configurations that may represented by data processing system 500, 600 include, but are not limited to, personal computer systems, server computer systems, thin clients, thick clients, wearable computer, hand-held or laptop devices, multiprocessor systems, microprocessor-based systems, network PCs, minicomputer systems, and distributed cloud computing environments that include any of the above systems or devices.

Computing device 110 includes respective sets of internal components 500 and external components 600 as illustrated in FIG. 6. Each of the sets of internal components 500 includes one or more processors 520, one or more computer-readable RAMs 522 and one or more computer-readable ROMs 524 on one or more buses 526, and one or more operating systems 528 and one or more computer-readable tangible storage devices 530. One or more of program function 112 and files 116 are stored on one or more of the respective computer-readable tangible storage devices 530 for execution by one or more of processors 520 via one or more of the respective RAMs 522 (which typically include cache memory). In the embodiment illustrated in FIG. 6, each of the computer-readable tangible storage devices 530 is a magnetic disk storage device of an internal hard drive. Alternatively, each of the computer-readable tangible storage devices 530 is a semiconductor storage device, such as ROM 524, EPROM, flash memory or any other computer-readable tangible storage device that can store a computer program and digital information.

Internal components 500 also include a R/W drive or interface 532 to read from and write to one or more portable computer-readable tangible storage devices 636, such as a CD-ROM, DVD, memory stick, magnetic tape, magnetic disk, optical disk or semiconductor storage device. Program function 112 and files 116 can be stored on one or more of the respective portable computer-readable tangible storage devices 636, read via the respective R/W drive or interface 532 and loaded into the respective computer-readable tangible storage devices 530.

Each set of internal components 500 also includes network adapters or interfaces 536 such as a TCP/IP adapter cards, wireless Wi-Fi interface cards, or 3G or 4G wireless interface cards or other wired or wireless communication links. Program function 112 and files 116 can be downloaded to computing device 110, respectively, from an external computer via a network (for example, the Internet, a local area network or other, wide area network) and respective network adapters or interfaces 536. From the network adapters or interfaces 536, program function 112 and files 116 in computing devices 110 are loaded into the respective computer-readable tangible storage devices 530. The network may comprise copper wires, optical fibers, wireless transmission, routers, firewalls, switches, gateway computers and/or edge servers.

Each of the sets of external components 600 can include a computer display monitor 620, a keyboard 630, and a computer mouse 634. External components 600 can also include touch screens, virtual keyboards, touch pads, pointing devices, and other human interface devices. Internal components 500 also include device drivers 540 to interface to computer display monitor 620, keyboard 630 and computer mouse 634. The device drivers 540, R/W drive or interface 532 and network adapters or interfaces 536 comprise hardware and software (stored in storage device 530 and/or ROM 524).

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, though the Internet using an Internet Service Provider).

Based on the foregoing, computer system, method and program product have been disclosed in accordance with the present invention. However, numerous modifications and substitutions can be made without deviating from the scope of the present invention. Therefore, the present invention has been disclosed by way of example and not limitation.

What is claimed is:

1. A system to ascertain the operational fitness of a mechanical system (“MS”) comprising
a MS facing (“MSF”) detector positioned proximate to the MS in a manner to detect acoustic pressure (“AP”) emanating from the MS;
a computing device in electrical communication with the MSF detector that correlates detected AP with the MS's operational profile and generates a notification when the correlated data exceeds a predetermined threshold by a predetermined percentage; and
wherein the computing device transmits the generated notification to a user-facing display.

2. The system of claim 1, wherein the predetermined threshold comprises a frequency, amplitude, tone, and/or harmonic.

3. The system of claim 1, wherein the operational profile comprises the MS's geospacial data, temperature, RPM, velocity, altimetry, and/or environmental humidity.

4. The system of claim 1, wherein the MSF detector comprises
a photon emitter that emits photons towards a non-MSF side of a reflective graphene diaphragm;
a photon receiver positioned adjacent to the photon emitter that captures at least a portion of the reflected photons;
wherein the diaphragm distorts in response to the acoustic pressure impacting a MSF side of the diaphragm, which results in change in a distance between the diaphragm and the photon receiver, which allows detection of the AP.

5. The system of claim 1, wherein the MS comprises an internal combustion engine, electric motor, and/or transmission.

6. The system of claim 1, wherein the MS is a system of elements that interact on mechanical principals.

7. The system of claim 1, wherein the predetermined threshold comprises historic AP measurements associated with the MS.

8. A method for ascertaining operational fitness of a MS comprising:
receiving, via a MSF detector positioned proximate to the MS, AP emanating of the MS;
correlating, via a computing device, received AP with the MS's operational profile;
generating a notification when the correlated AP exceeds a predetermined threshold by a predetermined percentage; and
transmitting, via a computing device, the generated notification to a user-facing display.

9. The method of claim 8, wherein the predetermined threshold comprises a frequency, amplitude, tone, and/or harmonic.

10. The method of claim 8, wherein the operational profile comprises the MS's geospatial data, temperature, RPM, velocity, altimetry, and/or environmental humidity.

11. The method of claim 8, wherein the MSF detector comprises
a photon emitter that emits photons towards a non-MSF side of a reflective graphene diaphragm;
a photon receiver positioned adjacent to the photon emitter that captures at least a portion of the reflected photons;
wherein the diaphragm distorts in response to the acoustic pressure impacting a MSF side of the diaphragm, which results in change in a distance between the diaphragm and the photon receiver, which allows detection of the AP.

12. The method of claim 8, wherein the MS comprises an internal combustion engine, electric motor, and/or transmission.

13. The method of claim 8, wherein the MS is a system of elements that interact on mechanical principals.

14. The method of claim 8, wherein the predetermined threshold comprises historic AP measurements associated with the MS.

15. A computer program product for ascertaining operational fitness of a MS, the computer program product comprising a computer readable storage medium having program code embodied therewith, the program code executable by a processor to:
receive, via a MSF detector positioned proximate to the MS, AP emanating of the MS;
correlate, via a computing device, received AP with the MS's operational profile;
generate a notification when the correlated AP exceeds a predetermined threshold by a predetermined percentage; and
transmit, via a computing device, the generated notification to a user-facing display.

16. The computer program product of claim 15, wherein the MSF detector comprises
a photon emitter that emits photons towards a non-MSF side of a reflective graphene diaphragm;
a photon receiver positioned adjacent to the photon emitter that captures at least a portion of the reflected photons;
wherein the diaphragm distorts in response to the acoustic pressure impacting a MSF side of the diaphragm, which results in change in a distance between the diaphragm and the photon receiver, which allows detection of the AP.

17. The computer program product of claim 15, wherein the predetermined threshold comprises a frequency, amplitude, tone, and/or harmonic.

18. The computer program product of claim 15, wherein the operational profile comprises the MS's geospatial data, temperature, RPM, velocity, altimetry, and/or environmental humidity.

19. The computer program product of claim 15, wherein the MS comprises an internal combustion engine, electric motor, transmission, and/or a system of elements that interact on mechanical principals.

20. The computer program product of claim 15, wherein the predetermined threshold comprises historic AP measurements associated with the MS.
